(19) United States
(12) Patent Application Publication
(10) Pub. No.: US 2025/0197588 A1
(43) Pub. Date: Jun. 19, 2025

(54) PREPARATION METHOD OF IMPACT-RESISTANT POLYESTER COMPOSITION

(71) Applicant: NAN YA PLASTICS CORPORATION, Taipei City (TW)

(72) Inventors: Te-Chao Liao, Taipei City (TW); Wen-Cheng Yang, Taipei City (TW); Chun-Che Tsao, Taipei City (TW); Chia-Yen Hsiao, Taipei City (TW); Yueh-Shin Liu, Taipei City (TW)

(73) Assignee: NAN YA PLASTICS CORPORATION, Taipei City (TW)

(21) Appl. No.: 18/413,056

(22) Filed: Jan. 16, 2024

(30) Foreign Application Priority Data
Dec. 14, 2023 (TW) 112148811

(51) Int. Cl. C08J 11/06; C08L 67/03

(52) U.S. Cl. CPC C08J 11/06; C08L 67/03; C08J 2367/02; C08J 2423/06; C08L 2205/08

(57) ABSTRACT

The disclosure provides a preparation method of an impact-resistant polyester composition, which is a continuous process and includes the following steps. A recycled release film is crushed, compacted and dried, and then melted, extruded and degassed. The recycled release film contains a recycled PET resin. After filtration, a liquid viscosifying system is used for thickening. Next, it is melted and kneaded, modified with modifiers and extruded. The modifiers include impact modifiers, compatibilizers, antioxidants and lubricants. After the rubber strips are cooled with water, they are then pelletized and dehydrated to produce the impact-resistant polyester composition.

### CROSS-REFERENCE TO RELATED APPLICATION

This application claims the priority benefit of Taiwan application serial no. 112148811, filed on Dec. 14, 2023. The entirety of the above-mentioned patent application is hereby incorporated by reference herein and made a part of this specification.

### BACKGROUND

### Technical Field

The disclosure relates to a preparation method of a polyester composition, and in particular, to a preparation method of an impact-resistant polyester composition.

### Description of Related Art

In response to corporate carbon reduction and ESG policies in various countries, the market is gradually leading to the trend of circular economy and plastic recycling. Without affecting the mechanical performance and processability, the introduction of environmentally friendly recycled materials with low carbon emissions will help to achieve global goals of reducing carbon emissions and saving energy. In the development of low-carbon materials, in addition to using recycled materials to reduce carbon emissions, production with low-carbon processes is also the focus of future development.

In the existing preparation method of modifying impact-resistant polyester materials from recycled materials, a segmented process is mainly adopted. In each process, the temperature must be raised, melted, viscosity improved, and then cooled for granulation. Repeated temperature rises and drops will generate energy, waste loss and carbon emissions increases. Therefore, this production method is inefficient and high energy consumption. More particularly, for example, process one, process two and process three can be carried out in a segmented manner. In the process one, the recycled release film is crushed, the broken film is compacted and dried, and then melted, extruded and degassed. After filtering, rubber strips cooling with water, pelletizing and dehydration, low-viscosity PET recycled granules can be obtained. After that, process two is carried out. In process two, the low-viscosity PET recycled granules are solid-state polymerized to form high-viscosity PET recycled granules. Finally, process three is carried out. In process three, the high-viscosity PET recycled granules are mixed and modified with a twin-screw using a modifier, and then the rubber strips are cooled by water, cut into granules and dehydrated to obtain impact-resistant polyester materials.

Based on the above, developing a preparation method of an impact-resistant polyester composition to improve production efficiency and reduce energy consumption, thereby complying with the global environmental protection trend of plastic reduction and energy conservation, is an important topic currently required for research.

### SUMMARY

The disclosure provides a preparation method of an impact-resistant polyester composition. Through continuous process modification, the impact-resistant strength of the PET material can be greatly improved from 3.6 kg-cm/cm to 56.2 kg-cm/cm. Therefore, it can replace ABS, PC, and PP in injection parts and extruded plates with high impact resistance requirements, such as casings, suitcases, food trays, etc.

The disclosure provides a preparation method of an impact-resistant polyester composition, which is a continuous process and includes the following steps. A recycled release film is crushed, compacted and dried, and then melted, extruded and degassed. The recycled release film contains a recycled PET resin. After filtration, a liquid viscosifying system is used for thickening. Next, it is melted and kneaded, modified with modifiers and extruded. The modifiers include impact modifiers, compatibilizers, antioxidants and lubricants. After the rubber strips are cooled with water, they are then pelletized and dehydrated to produce the impact-resistant polyester composition.

In an embodiment of the disclosure, the preparation method of the impact-resistant

polyester composition further includes removing and collecting a surface coating of the recycled release film before the recycled release film is crushed, compacted and dried.

In an embodiment of the disclosure, a temperature at which the recycled release film is crushed, compacted and dried is 70° C. to 120° C.

In an embodiment of the disclosure, a temperature of melting, extruding and degassing is 240° C. to 290° C.

In an embodiment of the disclosure, a temperature of melting and kneading is 240° C. to 280° C.

In an embodiment of the disclosure, a temperature of modification and extruding is 250° C. to 275° C.

In an embodiment of the disclosure, a temperature of cooling the rubber strips is 40° C. to 80° C.

In an embodiment of the disclosure, the impact modifiers include a polyethylene elastomer.

In an embodiment of the disclosure, the polyolefin elastomer has a dispersed particle size of 0.5 μm to 1.2 μm in the impact-resistant polyester composition.

In an embodiment of the disclosure, the compatibilizers include ethylene-methyl acrylate-glycidyl methacrylate copolymer (E-MA-GMA), polyolefin elastomer graft glycidyl methacrylate (POE-g-GMA), polyethylene graft glycidyl methacrylate glycerides (PE-g-GMA) or a combination thereof.

In an embodiment of the disclosure, the antioxidants include hindered phenolic antioxidants, phenolic antioxidants, mixed antioxidants, phosphite antioxidants, complex antioxidants or combinations thereof.

In an embodiment of the disclosure, the lubricant comprises stearates, polyethylene wax, siloxane modifier, or a fluorine-based resin.

In an embodiment of the disclosure, based on a total weight of the impact-resistant polyester composition, a content of the recycled PET resin is 70 wt % to 92 wt %, a content of the impact modifiers is 5 wt % to 15 wt %, a content of the compatibilizer is 2 wt % to 15 wt %, a content of the antioxidant is 0.1 wt % to 1 wt %, and a content of the lubricant is 0.1 wt % to 1 wt %.

Based on the above, the disclosure provides a preparation method of an impact-resistant polyester composition. Through continuous process modification, the impact-resistant strength of PET materials can be greatly improved from 3.6 kg-cm/cm to 56.2 kg-cm/cm. Therefore, it can replace ABS, PC, and PP in injection parts and extruded plates with high impact resistance requirements, such as casings, luggage, food trays, etc. In addition, the disclosure mainly adopts continuous molten state feeding and modification. In this way, compared with the segmented process in the prior art, it can avoid the waste of energy and the increase of carbon emissions. Therefore, the preparation method of the disclosure is efficient and more energy-saving.

### DESCRIPTION OF THE EMBODIMENTS

Embodiments of the disclosure will be described in details below. However, these embodiments are illustrative, and the disclosure is not limited thereto.

Herein, a range indicated by “one value to another value” is a general representation which avoids enumerating all values in the range in the specification. Therefore, the description of a specific numerical range covers any numerical value within the numerical range and the smaller numerical range bounded by any numerical value within the numerical range, as if the arbitrary numerical value and the smaller numerical range are written in the specification.

The disclosure provides a preparation method of an impact-resistant polyester composition, which is a continuous process and includes the following steps. First, a surface coating of a recycled release film is removed and collected. Next, the recycled release film is crushed, compacted and dried, and then melted, extruded and degassed. The recycled release film contains a recycled PET resin. After filtration, a liquid viscosifying system is used for thickening. Next, it is melted and kneaded, modified with modifiers and extruded. The modifiers include impact modifiers, compatibilizers, antioxidants and lubricants. After the rubber strips are cooled with water, they are then pelletized and dehydrated to produce the impact-resistant polyester composition.

In the present embodiment, the surface coating of the recycled release film is removed and collected to avoid affecting the hue and characteristics of the PET recycled particles. In addition, a liquid viscosifying system is used to increase the intrinsic viscosity (IV) from the viscosity range of 0.58 dl/g to 0.65 dl/g to the viscosity range of 0.70 dl/g to 0.86 dl/g. Functional modifications are performed to improve the strength and processability of the material, and to give the material functionality during application (such as impact resistance, etc.), so that it can be used in high-value products such as injection and extrusion.

In the present embodiment, a temperature for crushing, compacting and drying the recycled release film is, for example, 70° C. to 120° C.; a temperature of melting, extruding and degassing is, for example, 240° C. to 290° C.; a temperature of melting and kneading is, for example, 240° C. to 280° C.; a temperature of modification and extruding is, for example, 250° C. to 275° C.; and a temperature of cooling the rubber strips is, for example, 40° C. to 80° C.

In the present embodiment, modifiers can include impact modifiers, compatibilizers, antioxidants and lubricants. Below, the various components mentioned above will be described in detail.

In the present embodiment, the impact modifiers can include a polyethylene elastomer; the compatibilizers can include ethylene-methyl acrylate-glycidyl methacrylate copolymer (E-MA-GMA), polyolefin elastomer graft glycidyl methacrylate (POE-g-GMA), polyethylene graft glycidyl methacrylate glycerides (PE-g-GMA) or a combination thereof; the antioxidants can include hindered phenolic antioxidants, phenolic antioxidants, mixed antioxidants, phosphite antioxidants, complex antioxidants or combinations thereof; and the lubricant can include stearates, polyethylene wax, siloxane modifier, or a fluorine-based resin. Through compatibility modification, viscosity matching and mixing and dispersion technology, the compatibility between polyethylene elastomer and polyester materials is improved. After adjustment, the dispersed particle size of polyethylene elastomer in the impact-resistant polyester composition is, for example, 0.5 μm to 1.2 μm, so that the polyester material has the characteristics of high impact strength, high rigidity, low density and easy processing, and the impact strength can reach 56.2 kg-cm/cm.

In the present embodiment, based on a total weight of the impact-resistant polyester composition, a content of the recycled PET resin is, for example, 70 wt % to 92 wt %; a content of the impact modifiers is, for example, 5 wt % to 15 wt %; a content of the compatibilizer is, for example, 2 wt % to 15 wt %; a content of the antioxidant is, for example, 0.1 wt % to 1 wt %; and a content of the lubricant is, for example, 0.1 wt % to 1 wt %.

In summary, based on the above, the disclosure provides a preparation method of an impact-resistant polyester composition. Through continuous process modification, the impact-resistant strength of the PET material can be greatly improved from 3.6 kg-cm/cm to 56.2 kg-cm/cm. Therefore, it can replace ABS, PC, and PP in injection parts and extruded plates with high impact resistance requirements, such as casings, luggage, food trays, etc. In addition, the disclosure mainly adopts continuous molten state feeding and modification. In this way, compared with the segmented process in the prior art, it can avoid the waste of energy and the increase of carbon emissions. As a result, the preparation method of the disclosure is efficient and more energy-saving. On the other hand, the continuous process of the disclosure can reduce the molecular weight or IV loss of the material due to repeated temperature rise and cooling, making the impact-resistant modified particles have better impact resistance. (Continuous process of the disclosure: 56.2 kg-cm/cm; conventional segmented process: 43.0 kg-cm/cm) In addition to reducing the yield loss of the segmented process, the continuous process of the disclosure are all completed under high-temperature melt, which can avoid the energy consumption of repeated heating and cooling.

What is claimed is:

1. A preparation method of an impact-resistant polyester composition, which is a continuous process, comprising:
crushing, compacting and drying a recycled release film, and then melting, extruding and degassing the recycled release film, the recycled release film contains a recycled PET resin;
after filtration, using a liquid viscosifying system for thickening; and
performing melting and kneading, and modifiers are used for modification and extruding, the modifiers include impact modifiers, compatibilizers, antioxidants and lubricants, after cooling rubber strips with water, pelletizing and dehydrating to produce the impact-resistant polyester composition.

2. The preparation method of the impact-resistant polyester composition according to claim 1, further comprising removing and collecting a surface coating of the recycled release film before the recycled release film is crushed, compacted and dried.

3. The preparation method of the impact-resistant polyester composition according to claim 1, wherein a temperature at which the recycled release film is crushed, compacted and dried is 70° C. to 120° C.

4. The preparation method of the impact-resistant polyester composition according to claim 1, wherein a temperature of melting, extruding and degassing is 240° C. to 290° C.

5. The preparation method of the impact-resistant polyester composition according to claim 1, wherein a temperature of melting and kneading is 240° C. to 280° C.

6. The preparation method of the impact-resistant polyester composition according to claim 1, wherein a temperature of modification and extruding is 250° C. to 275° C.

7. The preparation method of the impact-resistant polyester composition according to claim 1, wherein a temperature of cooling the rubber strips is 40° C. to 80° C.

8. The preparation method of the impact-resistant polyester composition according to claim 1, wherein the impact modifiers include a polyethylene elastomer.

9. The preparation method of the impact-resistant polyester composition according to claim 8, wherein the polyolefin elastomer has a dispersed particle size of 0.5 μm to 1.2 μm in the impact-resistant polyester composition.

10. The preparation method of the impact-resistant polyester composition according to claim 1, wherein the compatibilizers include ethylene-methyl acrylate-glycidyl methacrylate copolymer (E-MA-GMA), polyolefin elastomer graft glycidyl methacrylate (POE-g-GMA), polyethylene graft glycidyl methacrylate glycerides (PE-g-GMA) or a combination thereof.

11. The preparation method of the impact-resistant polyester composition according to claim 1, wherein the antioxidants include hindered phenolic antioxidants, phenolic antioxidants, mixed antioxidants, phosphite antioxidants, complex antioxidants or combinations thereof.

12. The preparation method of the impact-resistant polyester composition according to claim 1, wherein the lubricant comprises stearates, polyethylene wax, siloxane modifier, or a fluorine-based resin.

13. The preparation method of the impact-resistant polyester composition according to claim 1, wherein based on a total weight of the impact-resistant polyester composition, a content of the recycled PET resin is 70 wt % to 92 wt %, a content of the impact modifiers is 5 wt % to 15 wt %, a content of the compatibilizer is 2 wt % to 15 wt %, a content of the antioxidant is 0.1 wt % to 1 wt %, and a content of the lubricant is 0.1 wt % to 1 wt %.
